(19) United States
(12) Patent Application Publication
(10) Pub. No.: US 2007/0029786 A1
(43) Pub. Date: Feb. 8, 2007

(54) Tamper indicating security device and method

(75) Inventor: Brian R. Morgan, La Jolla, CA (US)

Correspondence Address: GORDON & REES LLP, 101 WEST BROADWAY, SUITE 1600, SAN DIEGO, CA, 92101, US

(73) Assignee: Signat, LLC

(21) Appl. No.: 11/186,350

(22) Filed: Jul. 20, 2005

(51) Int. Cl. B42D 15/00

(52) U.S. Cl. 283/74

(57) ABSTRACT

A tamper indicating security device has a base and a separate cover which is snap engaged in a recess in the base with adjacent surfaces of the base and cover receiving at least part of a label having a signature area which extends across a junction between the base and cover surfaces. An elongate, flexible member has a first end secured to the base and a second free end for extending through eyelets of a closure of an item to be protected. Opposing inner faces of the cover and recess together form a trapper formation for receiving and trapping the free end of the elongate member so as to secure the security device across a closure. The free end of the elongate member cannot be released from the trapper formations without removing the cover and thereby destroying the label.

### BACKGROUND OF THE INVENTION

The present invention relates generally to tamper indicating devices or tags for providing evidence of tampering or unauthorized opening of various types of container or enclosure for containing valuables, private information, or the like, such as luggage, briefcases, jewelry boxes, desk drawers, folders, filing cabinets, or even rooms.

Most security devices for locking luggage, briefcases, and the like comprise keys or padlocks. These devices have the disadvantage that an unauthorized individual may be able to pick or circumvent the lock in order to gain access to the protected valuable items or confidential information, and then replace the lock. This leaves no evidence that the unauthorized individual has had access to the secured area. This is a particular problem in the case of secured secret, sensitive or confidential information, or secured evidence. When only one or a small number of people have access to an enclosure containing valuables or confidential information, it would be desirable if evidence of opening the enclosure was immediately apparent. Such immediately visible evidence would also be a deterrent to unauthorized individuals opening such containers or enclosures.

In my U.S. Pat. Nos. 5,452,930 and 5,568,951, security devices or tags similar to luggage label tags are described. The security devices have tamper indicating, personalized labels. The devices include a strap or tongue for threading through eyelets of a closure or the like, and the end of the strap is trapped in a closed position in the base of the device by a cover. A label with a signature area is applied over the cover, and the authorized user signs their name in the signature area. The arrangement is such that the cover cannot be opened to release the end of the strap without destroying the label. This makes it immediately apparent that the protected container or enclosure has been opened or tampered with, since unauthorized users will not be able to reproduce the signature even if they have access to another device or label.

### SUMMARY OF THE INVENTION

It is an object of the present invention to provide a new and improved tamper indicating security device and method.

According to one aspect of the present invention, a tamper indicating security device is provided, which comprises a base having opposite first and second surfaces, a recess in the first surface, a separate cover of shape and dimensions for snap engagement in the recess, the cover having an outer surface substantially aligned with the first surface of the base when engaged in the recess, the substantially aligned surfaces of the base and cover together forming at least part of a label receiving surface for receiving a label, an elongate, flexible member having a first end secured to the base and a second free end for extending through eyelets or the like on two parts of a container or closure to be protected, the base and cover when engaged together having trapper formations for receiving and trapping the free end of the elongate member so as to secure the security device across a closure, and a label having a signature receiving area on one face and an adhesive on the opposite face for securing the label to the label receiving area with the signature receiving area extending across a junction between the first surface of the base and outer surface of the cover, whereby the free end of the elongate member cannot be released from the trapper formations without removing the cover and thereby destroying the label.

The authorized user can insert their signature in the signature area of the label either before or after it is secured to the appropriate area of the assembled base and cover. The security device can be secured across a closure to a container or door, for example by extending the elongate member or tongue through eyelets or rings on different parts of a container such as a briefcase, suitcase, folder, filing cabinet, or the like, or the eyelets of two zipper tabs or a zipper tab and ring after a zipper is closed. In order to open the secured container or other enclosure, or an access door to an enclosed area, the elongate member has to be cut or the cover must be removed from the base to release the end of the elongate member, destroying the label in the process. In either case, the container or the like cannot be re-secured by an unauthorized user, since they will be unable to accurately reproduce the authorized user's signature. Thus, unauthorized opening of the container or other protected enclosure will be immediately apparent.

The security device may be simply discarded after use by an authorized user to first secure and then gain access to the secured area or container, and a new security device is then used to re-secure the closure or the like. Alternatively, the security device may be re-used by applying a new label after the cover is snapped back into engagement with the base and the elongate member is extended back through the eyelets or the like to re-secure the closure or container. The base and elongate member, which may be formed integrally, and the separate cover may be made of injection-molded plastic or other suitable material. The label may be paper, plastic, or other material suitable for receiving a signature, and the adhesive is a substantially permanent adhesive so that the label cannot be peeled off after application without destroying it.

In an exemplary embodiment of the invention, the label is of predetermined dimensions for wrapping around the first surface, one side, and the second surface of the base. A first portion of the label which is intended to be applied over part of the first surface of the base and aligned outer surface of the cover carries the signature area, and a second portion which will be applied over part of the second surface of the base may have a designated area for receiving name and address information and the like, similar to a luggage tag.

The label may have an opening at a location between the first and second portions for exposing part of the edge of the cover when it is engaged in the recess, providing access for removing the cover by an authorized user who wishes to access the secured enclosure or the like.

The base has opposite side edges and opposite ends, and one side edge may have an opening or cut out extending into the recess. In this embodiment, the cover has a projecting tab which extends into the opening in the side edge when the cover is engaged in the recess. The opening in the label is aligned with the opening or cut out when the label is adhered over the base and cover. The opening in the base provides a finger or thumb notch for an authorized user to engage under the tab of the cover and lever the cover off the base when they wish to access the protected container or enclosure. The opening in the label is positioned in alignment over the opening in the side edge of the base when the label is wrapped around the side edge, so that the thumb or finger notch is not concealed by the label.

One end wall of the base has an opening leading into the recess, and the cover has a corresponding opening which is aligned with the end wall opening when the cover is snapped in position over the base. The free end of the elongate member or tongue is inserted through the aligned openings into the base, which in turn are aligned with the trapping formations in the base and lid. In the exemplary embodiment, the tongue has at least two spaced teeth or barbs adjacent its free end which are angled away from the free end of the tongue. The trapping formations comprise spaced channel walls between the base and cover defining a channel for receiving the tongue, with one of the channel walls having a pair of inclined slots for receiving the teeth or barbs on the tongue such that the tongue cannot be pulled out of the base when fully engaged in the slots.

Eyelets with adhesive backing may be used in conjunction with the security device for applications where there are no existing eyelets, loops, rings, zipper pull tabs, or the like which can be used to cooperate with the elongate member or tongue to secure the device across a closure. The eyelets may be of plastic material or the like.

According to another aspect of the present invention, a method of securing an access opening to a container, enclosure, or secure area is provided, which comprises the steps of:

writing a personal signature in a signature area of a label applied over a base and removable cover of a security device, the signature area of the label overlying a junction between the base and cover such that the cover cannot be removed without destroying the signature, opposing faces of the base and cover together forming trapping formations;

extending the free end of a flexible tongue secured to the base at its opposite end through a pair of eyelets on opposite sides of a closure; and

inserting the free end of the tongue into the assembled base and closure such that the free end is trapped by the trapping formations to lock the security device across the closure such that the closure cannot be opened without cutting the tongue to release it from the eyelets or removing the cover from the base to release the trapped end of the tongue.

The security devices of this invention are small, lightweight, and relatively inexpensive. A supply of such devices can be easily carried around or stored for use as needed. Whenever an authorized user wishes to access a container or enclosure secured with a signed security device, they simply lever or pry the cover off the base, which simultaneously destroys the label, and release the tongue from the eyelets. The used security device is then simply discarded. When the container or enclosure is to be re-secured, the user signs their name in the label signature area and secures the device or tag across the closure in exactly the same manner. These devices are particularly useful when traveling, since the owner will know immediately if anyone has opened a suitcase or other secured container while it was in transit, or in a hotel room in their absence.

The tamper indicating security device of this invention may be used with any container, enclosure or other item having a closure, access opening, lid or door for access to the container or the like, including cases, bags, filing cabinets, dressers, jewelry boxes, cupboards, rooms, files, and the like. In the case of a room or cupboard, a door may be held closed by attaching a first eyelet to the door frame and a second eyelet to the door such that it is close to the first eyelet when the door is closed. The elongate member or tongue of a security device is then extended through the two eyelets and locked in the base. The door cannot be opened without destroying the security device or signed label, making unauthorized entry immediately apparent.

In the case of a suitcase, briefcase, bag or the like having a zipper fastener, the elongate member is extended through the zipper pull tab and a ring on the bag adjacent the closed end of the zipper, or through two zipper pull tabs or rings when the closure is of the type having two zippers. Other bags or suitcases will often have two rings or eyelets for receiving a padlock hasp, and these can be used for attachment of the security device of this invention. In each case, unauthorized access to the item being secured cannot be hidden from the authorized user, since their personalized signature secures the item and cannot be reproduced when the label is destroyed.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 is a perspective view of a label forming part of a security device according to an exemplary embodiment of the invention;

FIG. 2 is an exploded perspective view illustrating the base and cover or lid of the security device;

FIG. 2A is a perspective view illustrating the undersurface of the cover or lid of FIG. 2;

FIG. 3 is a perspective view of the security device with the lid snapped in place on the base;

FIG. 4 is a perspective view similar to FIG. 3 illustrating the label of FIG. 1 attached around the closed base of FIG. 3 to seal the closure, and the resultant device or security tag engaged through two eyelets of a container or the like;

FIG. 5 is a perspective view similar to FIG. 4, illustrating the opposite face of the device when closed and sealed as in FIG. 4;

FIG. 6 is a perspective view illustrating the cover removed from the base so that the signature label is torn and destroyed, and the elongate clasp or tongue member is released from the opened base;

FIG. 7 is a cross sectional view of the security device on the lines 7-7 of FIG. 4; and

FIG. 8 is a sectional view illustrating the locking engagement of the teeth of the clasp or tongue member in matching recesses in the undersurface of the cover.

### DETAILED DESCRIPTION OF THE INVENTION

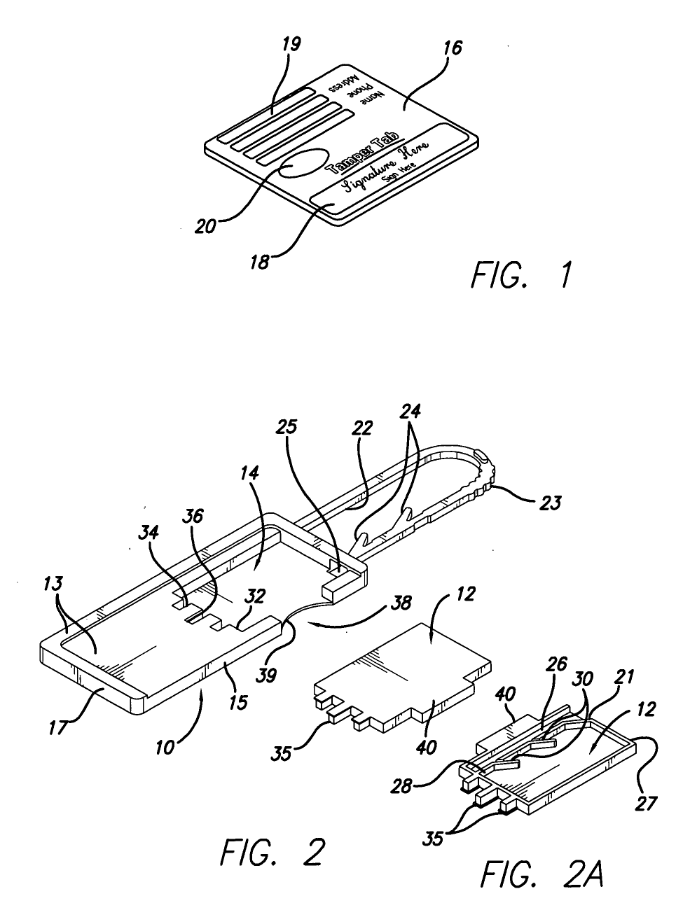

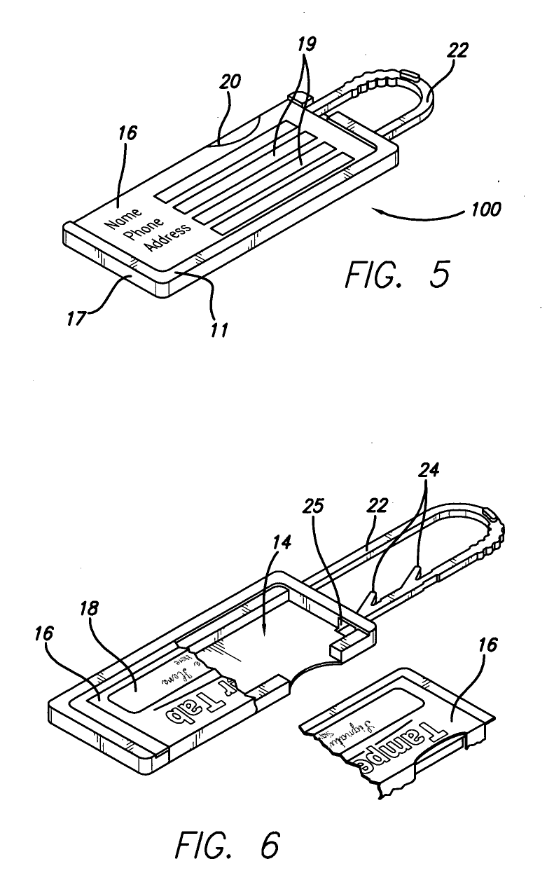

The drawings illustrate a tamper evident security device and method according to an exemplary embodiment of the present invention. FIGS. 1 and 2 illustrate the separate components of the device prior to assembly, while FIGS. 4 and 5 illustrate the parts assembled together to form a security device or tag 100 for securing any type of closure or to prevent unauthorized opening of an item without the owner or authorized user's knowledge.

The first component of the security device comprises a base 10 with a separate lid or cover 12 for snap engagement on the base, as illustrated in FIG. 2. FIG. 2 illustrates the cover oriented for engagement in a correspondingly shaped recess 14 in the base, while FIG. 2A illustrates the undersurface of the cover. The base and cover may be made of any suitable material such as injection molded plastic material or the like. The second component of the security device comprises a label 16 having a lower adhesive layer for adhering around the assembled base and cover in the manner illustrated in FIGS. 4 and 5, as will be described in more detail below.

The base 10 is a generally flat, rectangular member having a lower wall 11, upper wall 13, opposite side walls 15, and opposite end walls 17. One of the side walls 15 has an opening 38 leading into the recess 14, with the lower wall 11 having an arcuate finger or thumb notch 39 at the opening. One of the end walls 17 has an opening 25 adjacent one corner of the recess 14. The inner end wall 32 of the recess 14 has a series of indents 36 forming teeth 34, with the central indent being deeper than the outer two indents.

An elongate flexible strap or tongue 22 extends from the end wall of the base in which opening 25 is located. Tongue 22 extends from a location adjacent the opposite corner to opening 25, as can be seen in FIG. 2. Tongue 22 is generally U-shaped, with spaced, angled teeth 24 adjacent its free end which face inwardly. A portion 23 of the tongue adjacent the U-bend has corrugations or grooves for gripping purposes. A portion of the tongue 22 adjacent the second tooth 24 is thinner than the remainder of the tongue, to provide a weakened area.

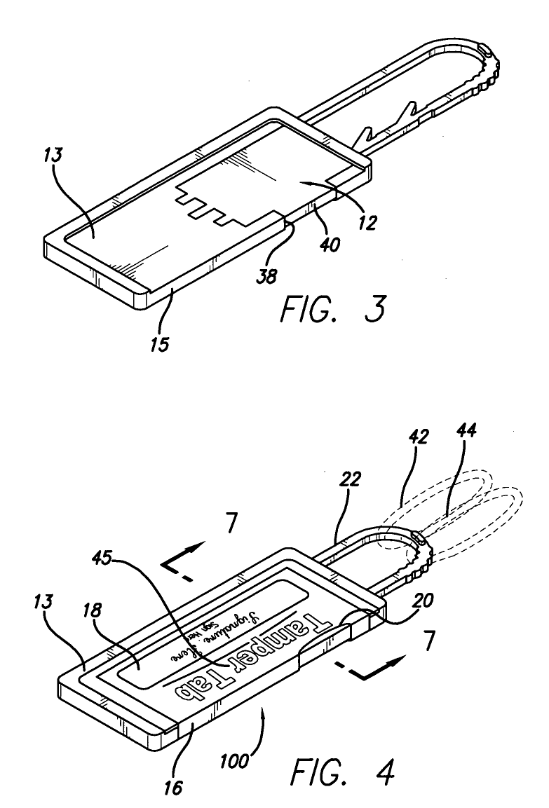

The lid or cover 12 has a shape and dimensions designed for snap engagement in recess 14, and has a series of three teeth 35 on one end located for mating engagement in the indents 36 in the end wall 32 of recess 14, and of matching dimensions to the indents. The central tooth 30 and control indent 36 are longer than the other teeth indents. The teeth and indents may be of any suitable watching shape, such as rectangular, painted, trapezoid, or the like. Cover 12 also has a projecting tab 40 on one side designed for engagement in opening 38 when the parts are snapped together as illustrated in FIG. 3.

The undersurface of the cover 12 is illustrated in FIG. 2A. The undersurface is recessed with a peripheral rim 27, and has an opening 21 at one corner which is designed to align with opening 25 in the end wall of the recess 14 when the parts are mated together. A channel-forming wall or barrier 28 extends between opposite ends of the undersurface of the cover at a location adjacent opening 21 to define a channel 26 between wall 28 and the adjacent side of rim 27. The wall 28 has inclined openings or slot formations 30 arranged to receive the teeth of tongue 22 when inserted in the channel 26, as will be described in more detail below.

The label 16 may be of paper, plastic, or other label material with a suitable substantially permanent adhesive applied to its lower surface. Indicia are provided on the upper surface of the label, comprising a signature area 18 in a first half of the label and an area 19 on the second half of the label for receiving identifying information such as a name, address, and/or phone number. An opening 20 is provided between the signature area 18 and the area 19. If desired, a logo or the like may also be provided on the label.

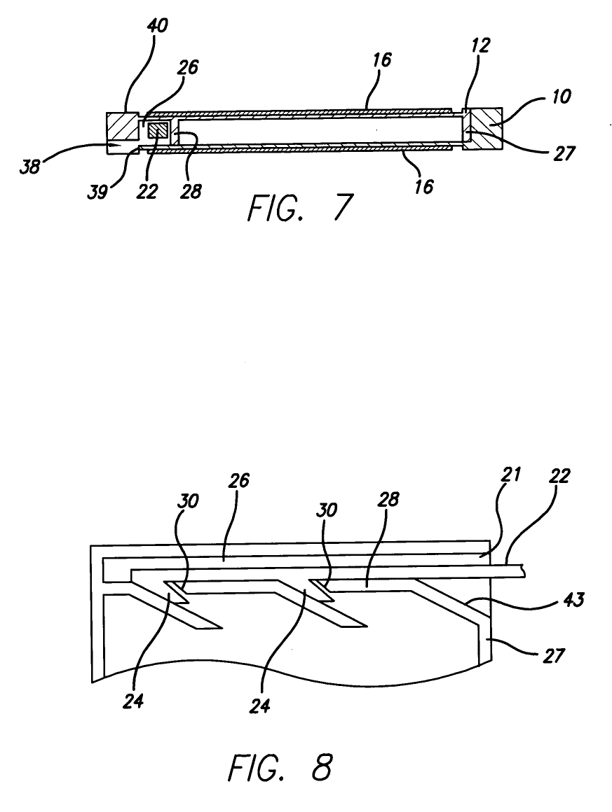

When the cover is snap engaged in the recess in the base, as indicated in FIG. 3, the upper surface of the cover will be aligned flush with the adjacent upper surface region of the base. As can be seen in FIG. 3, the resultant assembly is slightly indented over a large portion of the upper surface area to form a region for receiving part of the label 16. The undersurface of the base has a similar indented region, as can be seen in FIGS. 5 and 7. The dimensions of label 16 are such that a first half of the label carrying the signature area can be adhered in the indented region of the upper surface of the assembled base, and the remainder of the label can be wrapped around the side 15 of the base and adhered to the indented region on the lower surface of the base. The opening 20 is positioned so that it will reveal the tab 40 and thumb or finger notch 39 when the label is attached as illustrated in FIGS. 4 and 5.

Either before or after the label is attached to the base, a user can insert their signature 45 into the signature area 18. At the same time, the free end of tongue 22 is threaded through eyelets 42,44 or like devices on opposite sides of an opening to be sealed, and then inserted through openings 25 and 21 and into channel 26 formed between the base 10 and cover 12. Once inserted, a pull back on the tongue will result in engagement of the teeth 24 in slots 30, as best illustrated in FIG. 8. Opening 21 has a tapered inlet 43 on one side to allow the teeth to enter the channel more easily. Once teeth 24 are engaged in the slots, it will be impossible to remove the end of the tongue from the base due to the direction of the teeth and the dimensions of the channel, as will be appreciated from FIG. 8. If someone attempts to pull the end of the tongue out of the base, the weakened area adjacent the second tooth 24 will break or snap before the teeth break off or release. This ensures that the tampering cannot be concealed.

In the exemplary embodiment, the security device is supplied to the user (or a plurality of such devices may be provided in a single package) with the components already assembled as in FIG. 4, but with the end of the tongue free 22 and not inserted into the base (i.e. as in FIGS. 2 and 3). The user can apply a name and address or other information in area 19 on one side of the device 100, and can sign their name in signature area 20 on the other side. The free end of the tongue 22 is then threaded through any retaining devices for securing an opening or closure, and locked into the base in the manner described above. Eyelets 42 and 44 may comprise luggage or briefcase zipper tabs, or eyelets or rings provided for this purpose on a suitcase or briefcase closure. If the opening to be secured has no convenient eyelets, adhesive backed eyelets may be secured to opposite sides of an opening to be secured, as described in U.S. Pat. No. 5,568,951 referenced above, the contents of which are incorporated herein by reference.

Once the free end of the tongue 22 has been threaded through the appropriate eyelets, zipper tabs, zipper tab and ring, or the like and locked into the base, the case, container or other item to be secured cannot be opened by an unauthorized individual without the authorized user's knowledge. The only options for releasing the tongue from eyelets 42, 44 are either to snap the cover 12 off the base 10, as illustrated in FIG. 6, which simultaneously tears the signature label 16 as indicated, or to cut the tongue. In either case, the tampering will be immediately apparent. The unauthorized individual will be unable to replace the security device exactly as it appeared prior to the tampering. The label 16 is secured with substantially permanent adhesive, and cannot be peeled off the assembled base and cover without destroying the label. Even if the unauthorized user had access to a supply of such security devices, and re-secured the opening with a new device, they would be unable to accurately reproduce the signature of the authorized user.

The authorized user can easily remove the security device when they need to access the interior of the secured item, simply by snapping off the cover 12. The thumb or finger notch provides access to the undersurface of tab 40, allowing the user to apply leverage to release the cover and tear through label 16. The security device is then simply discarded, and replaced by a new security device when the user wishes to re-secure the opening or item in a closed condition.

The interengaging teeth and notches or indents on the cover 12 and base 10 will help to tear through and destroy the label when the cover is snapped off the base, either by an unauthorized individual or the authorized user. Unauthorized removal of the security device will either destroy the personalized signature on the label or destroy the security device itself, providing immediate evidence of tampering or opening various types of items, such as luggage, briefcases, desk drawers, filing cabinets, files, containers, and the like. This will help to protect valuable items, secret or sensitive information, evidentiary materials, and the like.

The tamper indicating device described above is quick and easy to apply, and is inexpensive, so that a plurality of such devices can be purchased in bulk for use in securing various items or for repeated securing of the same item after use. It is easier to manufacture than the prior device with a hinged lid, and the removable cover tears through the signature area of the label more reliably and effectively than the prior device. The device is relatively small and compact, and can be readily used as an address label for luggage or other items, in addition to its use as a personalized security device.

Although an exemplary embodiment of the invention has been described above by way of example only, it will be understood by those skilled in the field that modifications may be made to the disclosed embodiment without departing from the scope of the invention, which is defined by the appended claims.

What is claimed is:

1. A tamper indicating security device, comprising:
a base having opposite first and second surfaces and a recess in the first surface;
a separate cover of predetermined shape and dimensions for snap engagement in the recess, the cover having an outer surface substantially aligned with the first surface of the base when engaged in the recess;
the substantially aligned surfaces of the base and cover together forming at least part of a label receiving surface for receiving a label;
an elongate, flexible member having a first end secured to the base and a second free end for extending through eyelets of closure of an item to be protected;
the base and cover when engaged together having trapper formations for receiving and trapping the free end of the elongate member so as to secure the security device across a closure; and
a label having a signature receiving area on one face and an adhesive on the opposite face for securing the label to the label receiving area with the signature receiving area extending across a junction between the first surface of the base and outer surface of the cover, whereby the free end of the elongate member cannot be released from the trapper formations without removing the cover and thereby destroying the label.

2. The device as claimed in claim 1, wherein the base has opposite first and second sides and the label is of predetermined dimensions for wrapping around the first surface, first side, and the second surface of the base.

3. The device as claimed in claim 2, wherein the label has a first portion for application over part of the first surface of the base and aligned outer surface of the cover, the first portion having the signature area, and a second portion for application over part of the second surface of the base.

4. The device as claimed in claim 3, wherein the second portion of the label has a designated area for receiving name and address information.

5. The device as claimed in claim 2, wherein the label has an opening between the first and second portion, the opening being positioned for registration with an edge of the cover when the label is applied to the assembled base and cover.

6. The device as claimed in claim 5, wherein the first side of the base has an opening extending into the recess, the cover having a tab for engagement in the opening when the cover is engaged in the recess, the opening in the label extending over the first side of the base in registration with the tab of the cover to allow access to a user for removing the cover from the base.

7. The device as claimed in claim 1, wherein the cover has opposite side edges and opposite first and second end edges, and the recess in the base has opposite first and second ends corresponding to the first and second end edges of the cover, respectively, the second end of the recess being adjacent one end of the base, the first end edge of the cover having a first set of formations and the first end of the recess having a second set of formations for mating engagement with the first set of formations when the cover is in snap engagement in the recess.

8. The device as claimed in claim 7, wherein the first set of formations comprise teeth and the second set of formations comprise indents for receiving the teeth.

9. The device as claimed in claim 8, wherein the teeth include a central tooth which is longer than the remaining teeth.

10. The device as claimed in claim 1, wherein opposing surfaces of the cover and the recess in the base define a channel for receiving the free end of the elongate member, the channel having opposite side walls, the free end of the elongate member having teeth and one side wall of the channel having slots for receiving the teeth, and the channel and slots together locking the free end of the elongate member in the assembled base and cover when the teeth are engaged in the slots.

11. The device as claimed in claim 10, wherein the elongate member has a thinner, weakened region adjacent the teeth which is adapted to break if an unauthorized user attempts to pull the trapped end of the elongate member out of the base.

12. A tamper indicating security device, comprising:
a base having opposite first and second surfaces, opposite first and second sides, opposite ends, and a recess in the first surface;
a cover of predetermined shape and dimensions for snap engagement in the recess, the cover having an outer surface substantially aligned with the first surface of the base when engaged in the recess;
the substantially aligned surfaces of the base and cover together forming a partial label receiving surface for receiving part of a label;
an elongate, flexible member having a first end secured to the base and a second free end for extending through eyelets of closure of an item to be protected;
the base and cover when engaged together having trapper formations for receiving and trapping the free end of the elongate member so as to secure the security device across a closure;
a label having a first portion secured over the label receiving surface of the base and cover, the label extending around the first side of the base and having a second portion secured over part of the second surface of the base; and
the first portion of the label having a signature receiving area which extends across a junction between the first surface of the base and the outer surface of the cover, whereby the cover cannot be removed from the base without destroying the signature receiving area of the label.

13. The device as claimed in claim 12, wherein the first side of the base has a thumb notch and an opening above the thumb notch extending into the recess, the cover having a tab engaging in the opening, the thumb notch providing access to the tab for levering the cover from- the base when the device is to be removed from a secured item.

14. The device as claimed in claim 13, wherein the label has an opening of predetermined shape and dimensions between the first and second portions which extends over the tab and thumb notch.

15. The device as claimed in claim 12, wherein the second portion of the label has a predetermined area for receiving user name and address information.

16. The device as claimed in claim 12, wherein the elongate member has a corrugated gripping region.

17. The device as claimed in claim 12, wherein the elongate member is of a first predetermined thickness along the majority of its length, and has weakened region of a second thickness less than said first thickness.

18. A method of securing an access opening to a container, enclosure, or secure area, comprising the steps of:
applying a personal signature in a signature area of a label applied over a base and removable cover of a security device, the signature area of the label overlying a junction between the base and cover such that the cover cannot be removed without destroying the signature, opposing faces of the base and cover together forming trapping formations;
applying identifying information in an identification area of the label located on an opposite face of the base to the signature area;
threading the free end of a flexible tongue extending from the base through a pair of eyelets on opposite sides of a closure; and
inserting the free end of the tongue through an opening in the base into the assembled base and closure such that the free end is trapped by the trapping formations to lock the security device across the closure, whereby the tongue cannot be removed from the eyelets without cutting the tongue or removing the cover from the base to release the trapped end of the tongue.
